(19) United States
(12) Patent Application Publication
(10) Pub. No.: US 2024/0367292 A1
(43) Pub. Date: Nov. 7, 2024

(54) Three Jaw Wrench

(71) Applicant: Nigel Buchanan, Fife (GB)

(72) Inventor: Nigel Buchanan, Fife (GB)

(21) Appl. No.: 18/290,880

(22) PCT Filed: Jul. 21, 2022
(86) PCT No.: PCT/GB2022/051914

§ 371 Date: Jan. 22, 2024

(30) Foreign Application Priority Data
Jul. 21, 2021 (GB) 2110519.2

(51) Int. Cl. B25B 13/08; B25B 13/04; B25B 13/06; B25B 27/18

(52) U.S. Cl. CPC B25B 13/08; B25B 13/04; B25B 13/065; B25B 27/18

(57) ABSTRACT

A three jaw open wrench or socket 1, capable of having a “proof torque” over ten times that of the ASME 107.6 standard for equivalent sized heavy duty crowfoot socket or wrench, having an elongate handle portion 20 and incorporating at least one head portion 300, having an inner drive profile 301 robustly gripping in the drive torque direction D correspondingly near sized, metric or inch hexagonal fasteners 40 by three triangulated 305, equidistant 306, first 307, second 308 and third 309 torque application points, one engaging every second corresponding hexagonal fastener head 41 driven half face 43 in the direction of torque application D, the occurring projected forces PF simultaneously self centring the projected force PF, upon said worked fastener driven half faces 43, any slight variances in fastener drive flat to flats 42, manufacturing tolerances or worn or damaged fastener drive flats 46 being automatically compensated for in the same manner as a three legged stool compensates for an uneven floor.

### FIELD OF INVENTION

The present invention relates to a hand tool used for the operation of predominantly hexagonal, nuts, bolts and fasteners, in particular relating to an open end wrench or open box or ring wrench capable of being used to circumvent fastener elongate attachments such as obstructing tubes, pipes etc. attached to the fitting or fastener to be operated.

Pipes or tubes utilise pipe or tube nuts or fasteners to connect the pipework to the various hydraulic, pneumatic or fluid or air machines or controls. The tube nuts utilised are generally made from brass or other “soft” metals which can be easily damaged during dismantling especially when corrosion, sealant or the like causes the pipe-nut to be tighter than expected. When used on tight fasteners normal open ended or crowfoot wrenches tend to round off the corners of the flare nut drive flats often to a stage that they become inoperable.

In particular the three jaw wrench or socket portion is designed to work on overly tight, undersized or worn fasteners, with little chance of slippage through the use of three equidistant individual, or alternately three dual sets of torque application points, incorporated within equidistantly spaced three jaw chuck spaced like “jaws”, each “jaw” gripping every second driven half face of the worked hexagonal fastener head, bolt or nut.

### BACKGROUND TO THE INVENTION

Hex bolts, nuts, screws, and other similar threaded devices hereinafter termed fasteners are used to secure and hold multiple parts together.

A conventional open wrench is a tool used to provide grip and mechanical advantage in applying torque to turn engaged fasteners, it can further be utilized to operate such as to keep the complementary head part of the fastener from turning. One type of wrench is called an open-end wrench, which usually has a parallel U-shaped opening to grip two opposite, parallel faces of a fastener head. As torque is applied to the wrench head the torque is transmitted to the fasteners in the appropriate chosen drive direction. The said open-end wrench head is configured to be essentially a one direction wrench, the opposite working direction requiring the wrench to be flipped over.

As only the leading half of the hexagonal fastener head faces in the operated direction can be actually levered in the chosen drive direction, the fastener can typically only be operated by the two opposite leading halves or hereafter termed driven half faces of its hexagonal drive flats, the first usually largest operating jaw only actually requiring to be half its length in order to operate the said leading half of the correspondingly sized worked hexagonal fastener head driven half face, although the conventional shaped open-end wrench has a full length first operating jaw. In order to operate the fastener opposing driven half face, the conventionally shaped open-end wrench does require a full length second operating jaw, although this jaw is invariably less substantial in structure, the outmost tip of the second jaw face is normally the most vulnerable stress point of the actual wrench operating profile as it is also subject to the maximum lever arm force during operation of the worked corresponding hexagonal fastener head driven half face. Closed sockets, box or ring type wrenches are preferable to open jaw type wrenches because the torque arm force applied to the socket is transmitted to the fastener via a much larger contact area and the closed ring head of the socket or wrench is inherently stronger and therefore can transmit a far greater torque with less harmful distortion of the fastener head and less chance of the socket or wrench head damaging or slipping off the fastener. A typical open-end wrench has a wrench head which consists of two jaws each with parallel, smooth planar surfaces that engage the opposite sides of mainly hexagonal fasteners. In order to transmit without damage to either the fastener head or the operating wrench head the jaw surfaces require to be a snug fit upon the fastener hex flats, further requiring that only properly sized metric or inch wrenches should be used on the correspondingly sized fastener head if any reasonable amount of torque level is used. One of the most common problems in operating hexagonal headed fasteners using typical open wrench heads, whether on nuts or bolts, is the wrench head slipping on the operated fastener head. This can be caused by either a worn fastener, improperly sized wrench usage, corrosion, previous over tightening or previous damage to the operated fastener head or wrench head inner drive profile.

Prior art open-end wrenches suffer in that the jaws of such open-end wrenches tend to spread under load. This enables the fastener to rotate within the open-end wrench head, which damages the corners of the operated hexagonal or other polygonal fastener by rounding off the worked corners of the said fastener. This rotation moves the fastener outwards towards the weaker distal end of the wrench head jaw flats simultaneously abating the possible level of robustness of engagement of the wrench head jaw flats upon the opposing fastener driven flats or points. In operations requiring medium to high torque this can damage one or both the fastener and the wrench head, as the fastener becomes unseated in the jaws of the wrench, this occurrence of the fastener becoming unseated is colloquially referred to as “walking the wrench”.

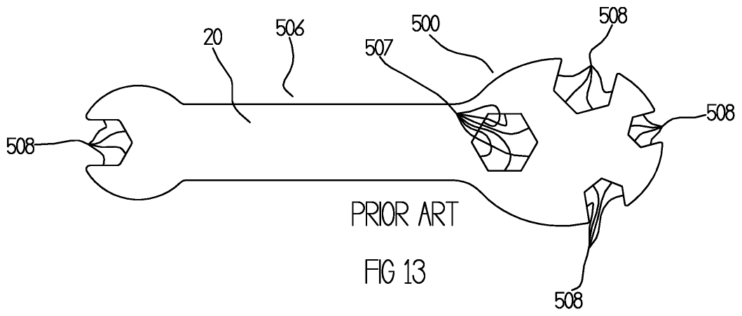

In order to lessen the occurrence of slippage when using such an open wrench the jaw driving surfaces can be roughened, high friction, ridged or even serrated as in U.S. Pat. Nos. 5,117,714, 5,148,726, 4,778,730, 6,276,240, 6,907,805, 8,667,873 or 9,120,210 and applications US 2019/0134787, US 2019/0015961 all these prior art wrench jaws use multiple ridges or protrusions on the opposing operating jaw surfaces and are incapable of much more “proof torque” (the maximum level of torque at which the open wrench head is rendered inoperable by means of its splaying or indeed breakage) than a conventional quality open wrench operating a good properly sized fastener. There are several prior art designs which have similar results but differing execution, wherein the fastener actual driven half face is usefully levered or driven only on the weaker outer portion of the second jaw or sometimes termed protruding tongue. As only the driven half face of the hexagonal fastener drive flats in for example the operated clockwise drive direction (the wrench head engaging the corresponding fastener head from generally the right hand side), can be utilized to actually operate the worked fastener in the chosen drive direction, any wrench head face abutting the non-driven half face of the hexagonal fastener drive flats when operated in the said clockwise drive direction cannot be utilized to operate the fastener. The simple flipping over of the wrench, allows drive in the opposite counter-clockwise direction. The best of this design of wrenches having only minimal improvement in proof compared to a high quality open-end wrench having jaw surfaces which are a snug fit upon the fastener hex driven half face. U.S. Pat. No. 6,269,715 in particular as best shown in FIG. 12 illustrating a ratcheting open-wrench whereas the fastener head 4 is driven by respective protuberances P2, P7 on the opposite jaw grips and a “supplementary” protuberance P5 urged in localized support upon the leading half of the said hex drive flats 43. Given that even high quality fastener hexagonal heads can normally be 1.5 to 2.5% undersized and the fastener hexagonal head corners are normally radiused contributing a further 2% reduction in the fastener hexagonal head corner to corner size, in best practice any wrench drive profile requires to be just far enough from the fastener hexagonal head corners to prevent detrimental corner contact with the said fastener hexagonal head corners, so that the said corners are not destructively rounded off during the application of any applied robust torque required. Empirical testing of such wrench designs has shown that the wrench head profile first or initial gripping or driving surface requires to be extremely robust in both shape and strength, as this is invariably the weakest point of this type of wrench head profile, The said U.S. Pat. No. 6,269,715 wrench in order to be able to ratchet, as shown in all depictions and has a useful first or initial gripping point of less than 6% of the length of a normal fastener hex drive flats from the fastener hex corners.

It is known that the most efficient operation of the fastener drive by any wrench profile is to apply the operating torque as close as possible to the corners or points of the fastener hexagonal drive profile. However, the closeness to these said corners can be problematic as these same corners are easily rounded off especially if the open-end wrench has jaw surfaces having less than snug fit upon the fastener hex flats.

U.S. Pat. No. 4,688,454A as illustrated and as claimed within all claims is a crowfoot type “wrench” operated by a separate wrench socket, within “a double square drive socket having eight notch shaped points” claim 1, “is an open ended, high torque wrench”, “for use on a nut of selected size to which there is limited access”, “having a jaw formed substantially as an arc,” “having an open-end” and “having two spaced opposing ends of the arc at the open-end, said open-end sized to engage said nut”, in tests using top grade chrome molybdenum instead of the industry standard but inferior chrome vanadium, correctly hardened using the specification given, resulted in proof torque of less than 250 in lbs nothing near the 1,800 in lbs specified.

As illustrated or constructed to any claim this device has useable torque only in a single direction, depicted in a clockwise direction, it is assumed flipping over for torque use in the anti-clockwise direction. Any use in the incorrect torque direction would and will result in so low a “proof torque” as to render the device un-usable.

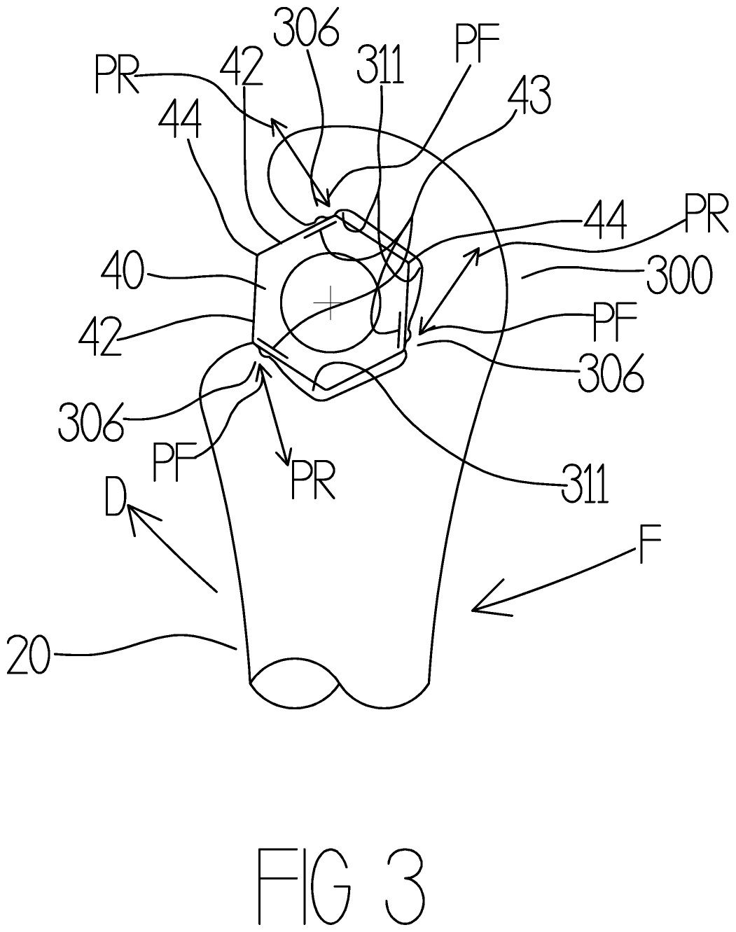

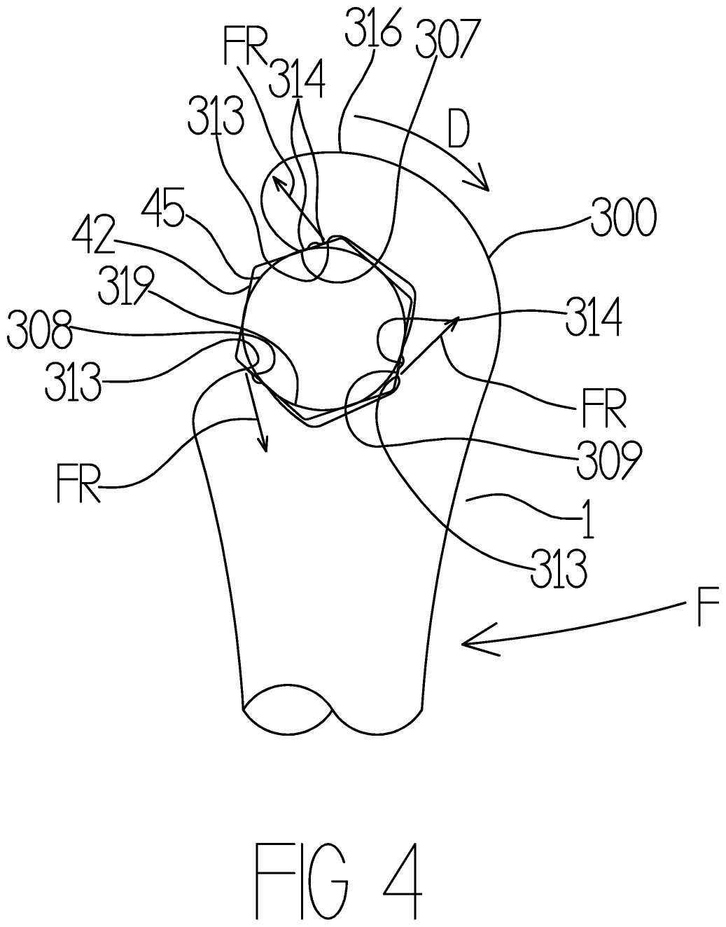

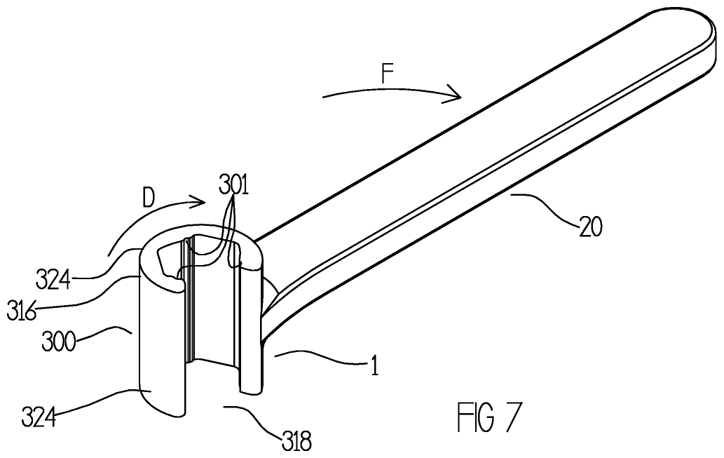

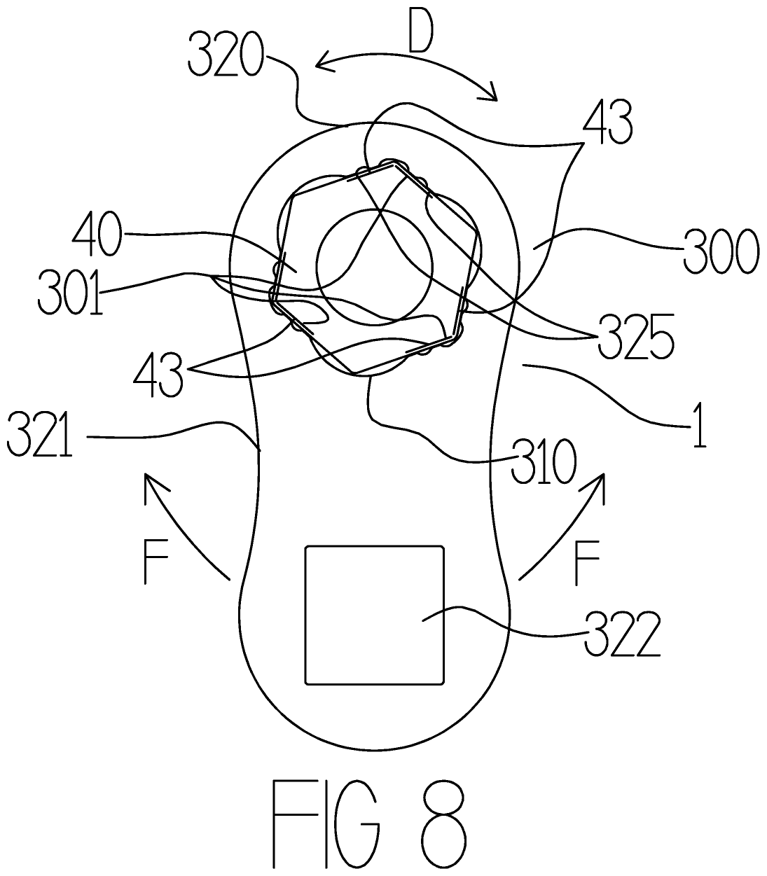

FIGS. 3, 4, 5, 6, 7 and 8 illustrating a box or ring type socket having approximately 110-120 degrees of its circumference removed. In what can be termed “the first iteration”, as shown in FIGS. 4 and 7, in order to allow direct access for the fastener to be operated, as in the illustrated clock-wise direction only two 102, 98 of the four flat walls 102,104, 96, 98 of the inner drive profile actually act to operate the worked fastener flat sides 108, 110 driven half faces, any lever arm force applied by the remaining two of four flat walls 104, 96 will and would merely urge the fastener out the open end 62. This iteration has no better and arguably less proof torque than a standard quality open-ended wrench or crowfoot, in correct test conditions using the specified dimensions and using top grade chrome molybdenum steel, correctly hardened, failures occurred at approximately 210 in lbs. Claim 1 further states, “said jaw being in tension around the nut as it is rotated to prevent said jaw from slipping on the nut”, this is clearly not the case in this iteration as only the outer jaw 58 is under tension, the inner jaw 60 clearly being under compression.

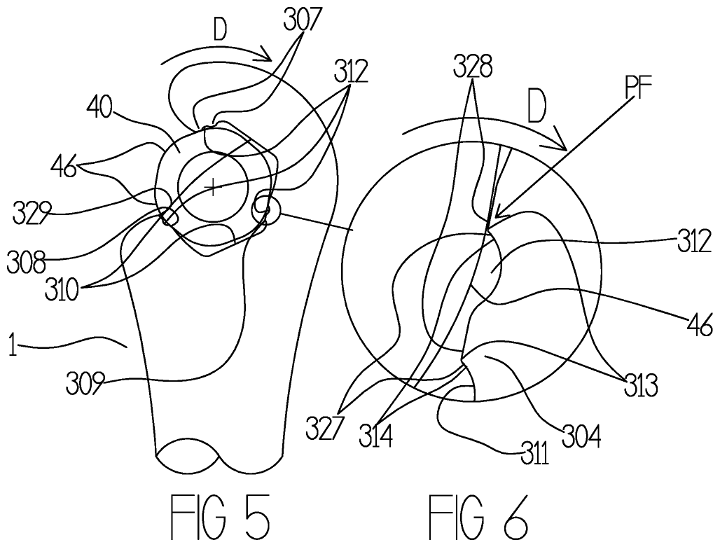

In the “second crowfoot type iteration” as illustrated in FIGS. 5 and 8, “said arced shaped jaw using notch-shaped points, each notch-shaped point having two flat walls,” “joined at their outer ends to form a notch-shaped point; said notch-shaped points being engageable with respective points of a properly sized nut”, in order to manufacture a crowfoot socket or wrench to this design with the quoted minimum 1,800 inch/pounds torque (requiring an ½″ socket drive) to an approximate scale according to FIG. 6, a ¾″ (19.1 mm) fastener operated size with an as stated, considerable socket wall thickness of 0.2″ (5.1 mm.) and a maximum specification depth of 0.405 inch (10.3 mm) would require a construction using expensive exotic tool steels as proper physical tests using top grade chrome molybdenum, which is a higher grade than chrome vanadium, correctly hardened, the test samples completely failed to meet their 1,800″lb torque minimum specification whereas the three jaw wrench to the identical specification, hardness and material can easily exceed this minimum specification.

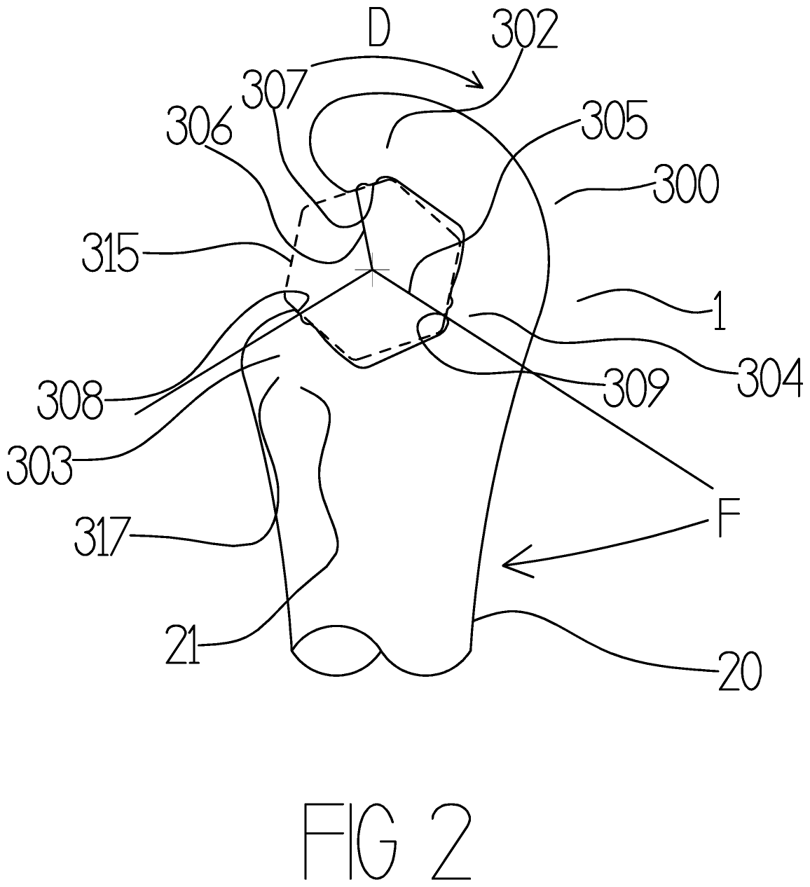

U.S. Pat. No. 7,146,884 denotes a two jaw open end wrench, head 14, according to claim 1, 6, 10 and 14 comprising two adjacent bite surfaces 24, 32 “disposed at an angle (Ft, Fc) greater than or equal to about 15 degrees and less than or equal to about 30 degrees with respect to the body axis” FIGS. 2B, 2C, 2D and in particular 2E, “between them a throat (web)” 18, the three jaw wrench designed to work at a similar angle of 5-10 degrees. Further claimed in claim 2, “wherein the (single) bite edges 29, 31 are of sufficient sharpness to plow into the fastener 36 sides” 46, 48 in order to drive the operated fastener 36 as illustrated in FIGS. 2E and 2F depicting the actual operation. As further described in the detailed description, “Plowing” “refers to the jaw bite edges and surfaces digging into the fastener head so that fastener material builds up in front of the bite surface”, “in order to achieve adequate plowing, the bite surfaces must be adequately sharp”. The operated fastener 36 if tight to operate would be damaged and in most circumstances leaving problematic sharp bur's. Furthermore claim 3 is specific in no engagement with a third torque application point. All the associated patents were allowed to lapse during or after 2010.

Many known, stamped metal plate, multiple function bicycle wrenches or spanners as they are known in the UK made since the 1940's till this present time, have their head portion fastener access 90 degrees to the handle portion. As the head width of these wrenches is unrestricted they perform well, if their depth were similar to normal wrenches they would easily exceed the required ASME 107.6 standard open wrench proof torque specification.

The majority of failures in all types of prior art open-end wrenches occur within the second jaw, as the normally susceptible tongue shaped prior art elongate second or bottom jaw with its leverage point at its extremity can cause the said second jaw to either flex or fail under anything but a perfect fit upon the fastener hex flats. In use on over tight for any reason fasteners, a professional would never presently in choice use an open wrench to slacken a tight fastener if a box or ring wrench or socket could possibly be used.

### SUMMARY OF THE INVENTION

Aspects of the present invention teach certain benefits in construction and use in which give rise to the exemplary advantages described below.

It is a general object of the three jaw wrench to provide a far more robust flare nut or crowfoot wrench, whilst having a fastener access bigger than any normal fastener corresponding elongate attachment such as a brake pipe, hydraulic pipe, fluid or air pipe, or any further tube, pipe or rod etc. utilized and which avoids some disadvantages of prior art wrenches while affording additional structural and operational advantages, or to provide an alternative to existing products at a lower manufacturing cost.

Throughout the following description specific details are set forth in order to provide a more thorough understanding to persons skilled in the art. However, well known elements may not have been shown or described in detail to avoid unnecessary obscuring of the disclosure. Accordingly, the description and drawings are to be regarded as illustrative, rather than in a restrictive sense. It is an object of the present invention to provide a low cost tool comprising a single piece three jaw wrench or socket portion with an extremely high torque capability, for example manufactured by industry standard forging, from industry standard steels and capable of several useful functions in one unique extremely robust three jaw wrench head or socket portion design.

The first embodiment is a three jaw wrench or socket comprising a triangulated three jaw operating profile and head portion design which provides far superior operating torque and proof torque than any known prior art similar width open-wrench or crow foot wrench or socket, the proof torque attainable being capable of over ten times that currently required by a similar sized heavy duty crowfoot under the ASME B107 standard, the test mandrill normally failing before the test three jaw wrench or socket, the operating profile is characterised in robustly gripping in the drive torque direction of use a correspondingly near sized worked hexagonal fastener by a triangulated grip operating profile, further termed equidistant torque application points, one engaging each second corresponding hexagonal fastener head or nut driven half face in the drive torque direction of lever arm force application, the occurring projected force simultaneously self centring upon the worked fastener driven half faces, any slight variances in fastener drive flat to flats manufacturing tolerances or worn or damaged fastener drive flats being automatically adjusted and compensated for in the same manner as a three legged stool compensates for an uneven floor.

Furthermore, allowing substantial reduction of the overall wrench head width, whilst considerably increasing the strength and torque capability of the head portion structure.

The second embodiment of the three jaw wrench or socket portion, whereas the head portion has a triangular grip operating profile and head portion design which firstly provides far superior operating torque by concentrating the torque applied to the corresponding worked fastener head driven half faces by the use of three separate generally equidistant torque application points, said torque application points comprising drive flats, other known drive profiles, or in best practice equidistant torque application points, whilst minimizing the damage to either the head portion or driven fastener head or nut drive flats or corner points. The three jaw wrench inner operating profile is notionally generally hexagonal in shape characterised by approximately one and a half lengths of the fastener faces or approximately 100 degrees of the said generally hexagonal shape being removed to form a substantial head portion elongate fastener attachment access.

The remaining generally part hexagon inner operating profile has concave arcuate corner profiles, these radii chosen to prevent stress cracks under high torque use. The torque application point leading edges when engaged usefully intersect only in the chosen drive torque direction the corresponding leading halves of the worked fastener drive flats hereafter termed the fastener driven half faces, forming in best practice three robust torque application points within the wrench head inner operating profile. Although smaller radiused torque application point leading edges having lower converging angles can be used, they exhibit much lower levels of torque use before damage to either the torque application point radiused leading edges or fastener driven half faces. The third embodiment of the three jaw wrench or socket portion comprises, wherein in order to construct as robust and compact a head portion as possible, the first and third torque application points within the head portion inner operating profile, when operated, are under tension as they grip and pull around, their corresponding fastener drive flat driven faces whilst the second torque application point is under compression as it pushes its corresponding fastener driven half face, characterized by the said torque application points contact with their corresponding worked fastener driven half face being initially in generally the same point within each said leading fastener drive half flat, constantly equalizing any lever arm force applied by each of the said torque application points upon said driven half faces of the worked fastener.

The fourth embodiment of the three jaw wrench is in order to further construct as robust and compact a wrench head as possible, the three jaw wrench head inner profile second jaw incorporates the second torque application point, the leading edge of which is specifically designed to operate under compression, gripping and pushing the corresponding fastener driven half face being worked, the resultant compressive force reaction being directed into the strong handle portion. Characterized by said second torque application point being incorporated within an extremely short and thick second jaw, the second torque application point, as far as prudent, comprising the point of convergence between the handle portion and the head portion, resulting in a far greater inherent open wrench head torque capability as the normally susceptible tongue shaped prior art elongate second jaw with its greatest drive capability at its extremity is the main cause of the prior art second jaw to either flex or fail.

The fifth embodiment of the three jaw wrench, comprises, a wrench head portion wherein as only the driven half faces of the hexagonal fastener drive flats, in one example in the operated clockwise drive direction (the wrench head engaging the corresponding fastener head from generally the right hand side), can be utilized to actually operate the worked fastener in the chosen drive direction, any wrench head face abutting the non-driven half of the hexagonal fastener drive flats when operated in the said clockwise drive direction cannot in any way be utilized to operate the said fastener. The present invention is characterised whereas its optimum point of engagement between the in best practice torque application point radiused leading edges and the said driven half faces of the fastener drive flats when used on undamaged fasteners is approximately 8-20% of the length of the operated fastener drive flat face from the driven half hex corners. This produces an three jaw wrench profile, or socket portion capable of robustly operating a corresponding hexagonal fastener head a full half size smaller than the said initial fastener head size, for example 12.5 mm instead of 13 mm, likewise a badly worn or damaged 13 mm fastener head size is still capable of being robustly operated at torque levels far above that of a prior art open or crowfoot wrench.

The sixth embodiment of the three jaw wrench or socket portion comprises, a head portion characterised wherein the optimum point of engagement between the torque application point leading edges and the said driven half faces of the fastener drive flats when used on undamaged fasteners is approximately 8-20% of the length of the operated fastener drive flat face from the fastener corner points on the smaller sizes of operated fastener and requires to be no more than 4 mm in from the adjoining fastener hex corner on the largest wrench head sizes, however if the operator requires a wrench head profile predominately for use on worn or very worn or damaged fastener heads the said percentage or indeed length from the adjoining operated fastener hex corner can be increased significantly, in best practice said point of engagement always remains upon the driven half faces of the fastener drive flats.

The seventh embodiment of the three jaw wrench, comprises an open-wrench or socket, inner drive operating profile characterized by the implementation of three generally equidistant torque application points the contact face of which being toothed, serrated or generally roughened. The central point of the inscribed circle of said torque application points being generally equivalent to the worked fastener head inscribed circle radius intersecting the said torque application points from the said central point, said torque application points being further capable of automatically self-centring upon and equally operating on at full force torque upon any undulations still remaining comprising the worked fastener worn or damaged driven half faces out with said inscribed circle.

The eighth embodiment of the three jaw wrench comprises, first, second and third torque application points which can comprise the utilization of many different profiles, the most universally useful being characterized by the torque application points utilizing radiused leading edges which have the greatest overall advantages, the leading edges of which comprise a radius the size of which is chosen according to the wrench commercial requirements, the smaller said leading edge radius, the greater the grip provided for use on worn or damaged fasteners, a larger leading edge radius utilized where new or undamaged fasteners are worked. In order to promote as robust as possible inner operation profile, the rear aspect of the torque application points radiused leading edges, comprises a larger smooth radius or straight profile merging into the wrench head inner drive profile, the rear aspect of the said leading edge radius nearest the corner profiles, in best practice merging into the adjacent concave arcuate corner profiles. The said torque application point radiused leading edges may be singular or in sets according to the market requirements.

The ninth embodiment of the three jaw wrench, or socket portion comprises a three generally equidistant torque application point operating profile, being further capable of adapting to and operating upon at full force torque, both metric and inch and vice versa near sized hexagonal fastener heads or nuts.

The tenth embodiment of the three jaw wrench or socket portion whereas the fastener driven half faces can differ in shape from those illustrated as many differing fastener or workpiece profiles exist, all of which further profiled torque application point types could be incorporated according to the operators requirements or manufacturers needs whilst not deviating from the basis of the present invention.

The eleventh embodiment of the three jaw wrench, comprises a closed box head portion profile similar to a known box or ring wrench or closed socket but implementing the said triangular grip operating profile.

If the wrench requires to be utilized in the opposite direction the wrench is simply flipped over. While one or more preferred embodiments of the invention have been described above, it should have been understood that any and all equivalent realisations of the present invention are included within the scope and spirit thereof. The embodiments depicted are presented by way of example only and are not intended as limitations upon the present invention. Thus, it should be understood by those of ordinary skill in this art, that the present invention is not limited to these embodiments since modifications can be made. Therefore, it is contemplated that any and all such embodiments are included in the present invention as may fall within the scope of appended claims.

### A MARSHALING OF REFERENCE NUMERALS UTILIZED IN THE DRAWINGS

Following is a listing of the components used in the best mode preferred embodiment and alternative embodiments. For the ready reference of the reader the reference numerals have been arranged in ascending numerical order.

| | |
|---|---|
| 1/Three Jaw Wrench | 329/Second Jaw Outer Point |
| 20/Handle Portion | |
| 21/Handle Portion Head Convergence Point | |
| 300/Head Portion | |
| 301/Inner Operating Profile | 40/Fastener |
| 302/First Jaw | 41/Hexagonal Fastener Head |
| 303/Second Jaw | 42/Fastener Drive Flats |
| 304/Third Jaw | 43/Fastener Driven Half Faces |
| 305/Triangular Grip Operating Profile | 44/Fastener Corner Points |
| 306/Equidistant Torque Application Points | 45/Fastener Inscribed Circle |
| 307/First Torque Application Point | 46/Worn/Damaged Fastener Undulations |
| 308/Second Torque Application Point | 47/Fastener Elongate Attachment |
| 309/Third Torque Application Point | 48/Fastener Non-Driven Half Faces |
| 310/Inner Drive Hex. Profile Non-Grip Faces | |
| 311/Concave Arcuate Corner Profiles | 500/Prior Art Wrench Head |
| 312/Torque Application Point Arcuate Recesses | 501/Prior Art Wrench Handle |
| 313/Torque Application Point Radiused Leading Edges | 502/Prior Art First Operating Face |
| 314/Inner Drive Hex. Profile Flat Faces | 503/Prior Art Second Operating Face |
| 315/Notional Hexagonal Shape | 504/Prior Art Notch Shaped Drive Face |
| 316 Head Portion Outer Profile | 505/Prior Art Notch Shaped Points |
| 317/Head Portion Handle Convergence Point | 506/Prior Art Bicycle Wrench |
| 318/Fastener Elongate Attachment Access | 507/Prior Art Full Hexagonal Profile |
| 319/Operating Profile Inscribed Circle | 508/Prior Art Part Hexagonal Profile |
| 320/Closed Box Head Portion | |
| 321/Head Portion Extension | 60/Obstruction |
| 322/Square Drive Spigot Recess | |
| 323/Dual Direction Torque Application Points | D/Drive Torque Direction |
| 324/Head Portion Deep Profile | F/Lever Arm Force |
| 325/Dual Sets Of Torque Application Points | PF/Projected Force |
| 326/Socket Portion | FR/Force Reaction |
| 327/Leading Edge Radius Rear Aspect | |
| 328/Leading Edge Radius Front Aspect | |

### BRIEF DESCRIPTION OF THE DRAWINGS

A full and enabling disclosure of the present invention including the best mode thereof, directed to one of ordinary skill in the art, is set forth in the specification, which makes reference to the appended drawings, in which:

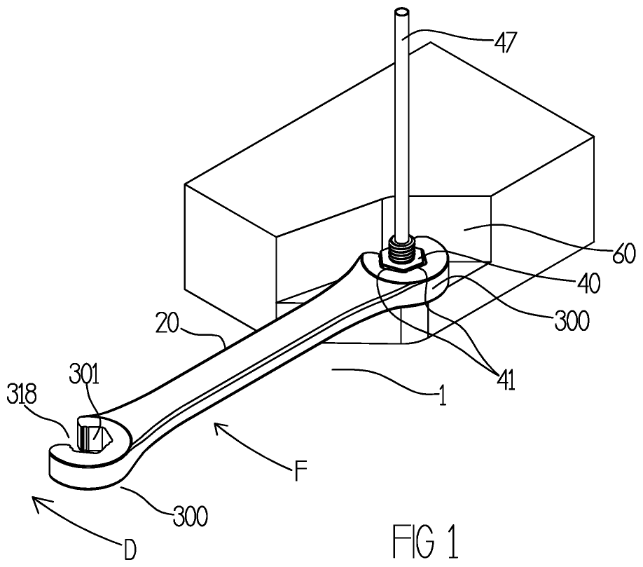

FIG. 1 is a perspective view of the three jaw wrench, shown with two sizes of head portion, one at either end. Also illustrating the three jaw wrench engaged upon a fastener having an elongate attachment, the fastener in close proximity to an obstruction.

FIG. 2 is a close up plan view of the three jaw wrench head, showing the inner operating profile of the head portion, further illustrating the notional hexagonal shape of the head portion inner operating profile.

FIG. 3 is a close up plan view of the three jaw wrench, the head portion torque application points shown correspondingly engaged upon the driven half faces of an under-sized sized fastener in the drive torque direction and the different forces employed.

FIG. 4 is a close up plan view of the three jaw wrench, head portion, the torque application points shown correspondingly engaged upon correctly sized fastener driven half faces in the drive torque direction. Further denoting the operating profile inscribed circle and the hexagonal fastener drive flats inscribed circle.

FIG. 5 is up plan view of the three jaw wrench, head portion, torque application points, shown correspondingly engaged upon damaged/worn fastener undulations, in the drive torque direction.

FIG. 6 is a very close up plan view of a torque application point radiused leading edge engaged upon a damaged/worn fastener, driven half face undulation.

FIG. 7 is a perspective view of the three jaw wrench, head portion utilizing a deep socket like profile.

FIG. 8 is a plan view of the three jaw wrench, closed ring head portion, version shown engaged upon a correspondingly sized fastener, for further illustration the handle portion being replaced by a short extension and a square drive spigot recess.

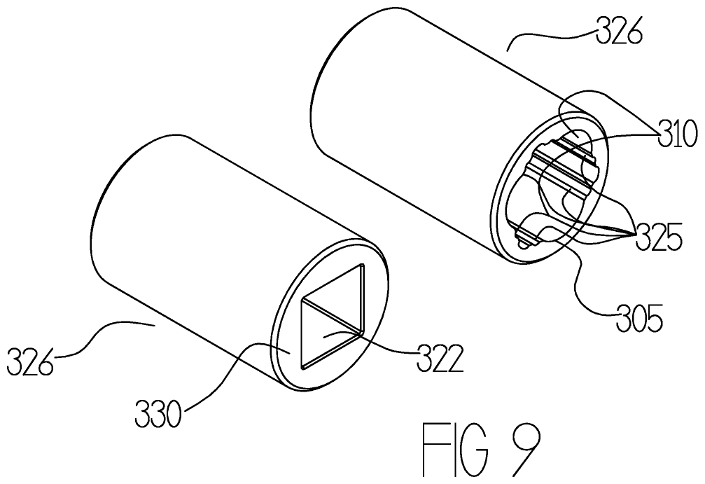

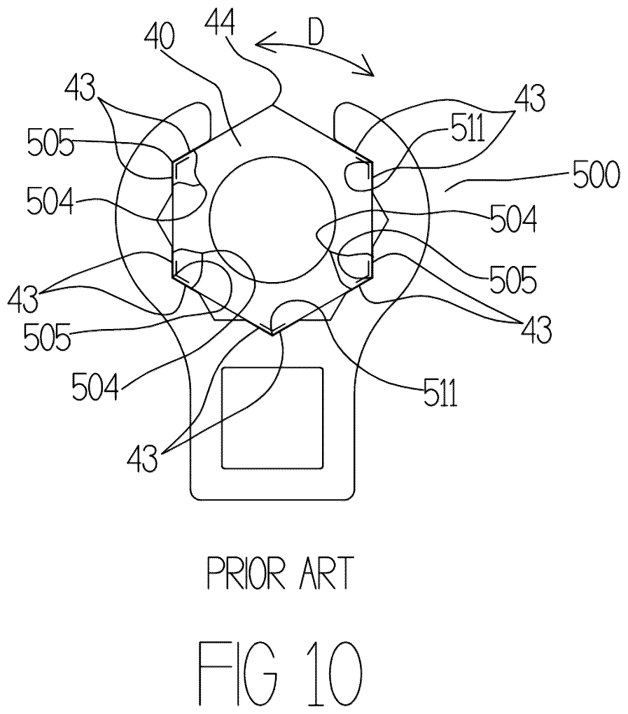

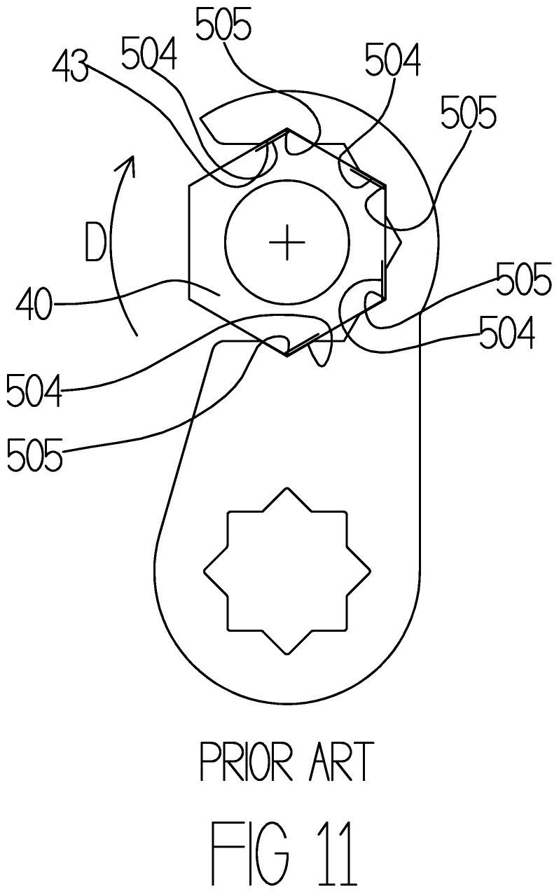

FIG. 9 is a perspective view of a three jaw dual direction socket, utilizing an inner operating profile comprising dual direction torque application points FIG. 10 is a plan view of a typical prior art dual direction crowfoot wrench head.

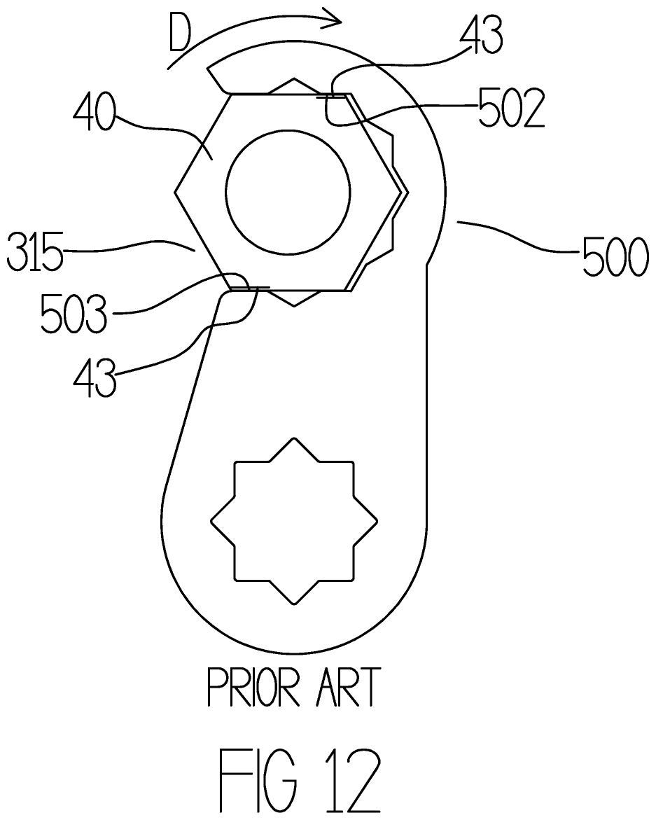

FIG. 11 is a plan view of a further example of a prior art crowfoot socket with the fastener elongate attachment access turned 90 degrees from normal, engaging by opposing, notch shaped points, correspondingly sized fastener corner points.

FIG. 12 is a plan view of a single direction prior art crowfoot socket engaging by opposing flats, correspondingly sized opposing fastener flats, the fastener elongate attachment access turned 90 degrees from normal.

FIG. 13 is a plan view of a further typical prior art bicycle wrench with the fastener access turned 90 degrees from normal.

### DETAILED DESCRIPTION

Referring to the drawings as shown in,

FIGS. 1 to 9 illustrate a three jaw open-wrench 1, constructed in accordance with the claims, FIGS. 8 and 9 illustrate further iterations constructed in accordance with the claims, utilizing a closed box head portions 320 or socket portion 326 incorporating dual sets of torque application points 325, FIGS. 10, 11, 12 and 13 denote examples of prior art crowfoot socket and open-wrenches 500.

The three jaw wrench 1 or closed box head portion 320, socket portion 326 utilizing dual sets of torque application points 325, provides a low cost tool that can be a stand-alone open- or box wrench or crowfoot socket or conventional socket used in conjunction with known square drive hand tools (not shown).

As depicted in FIGS. 1-7 a one piece, normally steel wrench having a planar overall shape, a single direction, three jaw wrench 1, utilized for the tightening or slackening of known hexagonal headed nuts, bolts, or accessing various fasteners, hydraulic or air fittings etc. attached to pipework, tubes, rods etc. hereinafter termed fasteners 40 and fastener elongate attachments 47, comprising:
a three jaw wrench 1, having an elongate planar handle portion 20 for the application of lever arm force F, to at least one head portion 300, said head portion 300 having an inner operating profile 301 capable of robustly gripping in the drive torque direction D a correspondingly sized fastener head 41, for the tightening or slackening of a fastener 40. Characterized by said inner operating profile 301 incorporating three separate equidistant torque application points 306, establishing a triangular grip operating profile 305 comprising the first 307, second 308 and third 309 torque application points, within the first 302, second 303 and third 304 jaws although several known prior art operating face types could be utilized, in best practice said equidistant torque application points 306 further comprise radiused leading edges 313 which during operation, engage correspondingly sized worked fastener 40, hexagonal fastener head 41, drive flats 42, driven half faces 43, in the drive torque direction D application, the occurring force reactions FR within the operated wrench head portion 300 projecting into the deepest sections of the wrench head outer profile 316. Said inner operating profile 301 purposely automatically adjusts and equally applies the projected force PF via said equidistant torque application points 306, similar in use to a known three legged stool (not shown) upon an uneven floor, upon the worked fastener driven half faces 43 when operated in the chosen drive torque direction D. In order to further construct as robust and compact a wrench head portion 300 as possible, said head portion inner operating profile 301 is further characterized by the second torque application point 308 which in use is under compression being incorporated within the second jaw 303 as far as is prudent within the point of convergence 21, 317 between the handle portion 20 and the head portion 300, the second jaw 303 outer point 329 furthermore forming a radiused leading edge 313, this results in a far greater inherent open wrench 1 head portion 300 torque capability as the first and third jaw 302, 304 which in use are under tension being pulled around against the worked fastener 40 driven half faces 43 the second torque application point 308 being under compression pushing its corresponding driven half face 43.
The head portion 300 inner drive profile 301 being notionally hexagonal in shape 315 with part of said hexagonal shape 327 removed to form the fastener elongate attachment access 318, the remaining inner drive hexagonal profile flat faces 314 having in best practice concave arcuate corner profiles 311, the torque application point radiused leading edges 313 formed at the point of convergence between the forgoing inner drive hex. profile flat faces 314 of the first and third jaws 302, 304 and said concave arcuate corner profiles 311 create the first jaw 302 and third jaw 304 torque application point radiused leading edges 313, in best practice further radiused leading edges 313 can be formed within said inner drive hexagonal profile flat faces 314 by further torque application point arcuate recesses 312. The second jaw outer point 329 forming the second torque application point 308. These triangular grip operating profile 305 torque application point radiused leading edges 313, capable of engaging correspondingly sized fastener drive flat 42 driven half faces 43 in the direction of the drive torque application D, all concave arcuate corner profiles 311 and torque application point arcuate recesses 312 radii chosen to prevent stress distortion or cracks under high torque use.

FIGS. 2-7 further depict the present three jaw wrench 1, illustrating the inner operating profile 301 notional hexagonal shape 315, incorporating said three separate equidistant torque application points 306, within the first 302, second 303 and third 304 jaws, establishing a triangular grip operating profile 305 comprising the first 307, second 308 and third 309 torque application points. Said head portion 300 inner drive profile 301 is characterized by the second jaw 303 second torque application point 308 being incorporated substantially within the extremely strong outer points of convergence 21, 316 between the handle portion 20 and the head portion 300.

FIG. 1 further shows the three jaw wrench 1, with two sizes of head portions 300, one either end of the handle portion 20, illustrating said wrench 1, head portion 300 engaged upon a fastener 40 hexagonal head 41 incorporating a fastener elongate attachment 47, which is in close proximity to an obstruction 60, even further depicting said head portion 300, inner drive profile 301 and the head portion 300, fastener elongate attachment access 318, the lever arm force F applied to said three jaw wrench 1 is projected in the drive torque direction D.

FIG. 2 further shows the three jaw wrench 1, head portion 300, in the drive torque direction D having a triangular grip operating profile 305 with its torque application points 307, 308 and 309 within the first 302, second 303 and third 304 jaws,

The head and handle portions convergence points 317, 21, close proximity to the second jaw 303 and handle portion 20, further denoted.

FIG. 3 further shows the head portion 300 equidistant torque application points 306 shown correspondingly engaged upon the driven half faces 43 of an under-sized sized fastener 40 in the drive torque direction D. Further illustrated are the fastener 40 drive flats 42 and corner points 44 and the concave arcuate corner profiles 311, further illustrating the projected force PF and force reaction FR as lever arm force F is applied to the handle portion 20 in the correct drive torque direction D.

FIG. 4 further shows the head portion 300, said inner drive operating profile 301, equidistant torque application points 306 shown correspondingly engaged upon correctly sized fastener 40 driven half faces 43 in the drive torque direction D, further illustrating the operating profile inscribed circle 319 and the hexagonal fastener drive flats 42 inscribed circle 45. The lever arm force F applied in the drive torque direction D with the lever arm force |F reactions FR projected into the deepest parts of the head portion outer profile 316. Further illustrating the inner drive hex. profile flat faces 314, first 307, second 308 and third 309 torque application point, arcuate recesses 312 and radiused leading edges 313.

FIGS. 5 and 6 further depicting the three jaw wrench 1, operated in the drive torque direction D upon a fastener 40 comprising severely worn or damaged fastener undulations 46 by the first 307, second 308 and third 309 torque application point radiused leading edges 313, as further illustrated in FIG. 6 when the fastener has severely worn or damaged undulations 46 only the said radiused leading edge 313 created at the intersection of the torque application point arcuate recesses 312 and the inner drive hex. profile flat faces 314, can usefully impart projected force PF upon the worn or damaged fastener undulations 46, as in the depiction shown the torque application point radiused leading edges 313 created at the leading edge front aspect 327 of the concave arcuate corner profiles 311 or torque application point arcuate recesses 312 and the inner drive hex. profile flat faces 314. Further illustrated are the leading edge rear aspects 328 and the inner drive hex profile non-grip faces 310.

FIG. 7 further shows a head portion 300 with a deep profile 324 for use where a fastener 40 is in a recessed situation (not shown). Further illustrated are, the head portion deep profile 324, inner operating profile 301, fastener elongate attachment access 318, head portion outer profile 316, handle portion 20, the lever arm force F and drive torque direction D.

FIG. 8 further illustrates a further method of operating the three jaw wrench 1, whereas the handle portion 20 (not shown) can be replaced or augmented by a head portion 300 extension 321 incorporating a square drive spigot recess 322 which in cooperation with known square spigot drive tools (not shown) can be utilized to operate the engaged fastener 40 in the drive direction D. further illustrated is the utilization of a closed box head portion (in the UK ring head) 320 capable of operating the three jaw wrench 1 in either clockwise or counter-clockwise drive torque direction D the inner operating profile 301 having three dual sets of equidistant torque application points 325 available for use upon the worked fastener 40 driven half faces 43.

FIG. 9 further illustrates the utilization of a closed box head portion 320 incorporated in a known socket portion 326, the inner operating profile 301 of which having three dual sets of equidistant torque application points 325 capable of operating in either clockwise or counter-clockwise drive torque direction D a worked fastener 40 driven half faces 43 (not shown), the inner drive hex. profile non-grip faces 310 are also shown.

FIG. 10 illustrates a typical crow foot prior art wrench head 500 as denoted in U.S. Pat. No. 4,688,454 further incorporating notch shaped points 511 incorporating notch shaped drive faces 510 in order to drive a fastener 40 corner points 44 driven half faces 43. Even the “heavy duty” examples of this dual drive direction D, wrench or socket 500 are only capable of relatively low proof torques.

FIG. 11 further illustrates a side entry prior art crow foot wrench head 500 as denoted in U.S. Pat. No. 4,688,454 FIG. 6, further incorporating notch shaped points 511 further incorporating notch shaped drive faces 510, operating in the drive torque direction D, a fastener 40 by its fastener driven half faces 43. Half inch drive, ⅝″ examples made to their specification as in FIG. 6, from highest grade chrome molybdenum and correctly hardened completely failed at approx. 62 Nm/540 in lbs far short of their quoted 1,800 inch lbs minimum working torque.

FIG. 12 even further illustrates a side entry prior art crow foot wrench head 500 as denoted in U.S. Pat. No. 4,688,454 FIGS. 4, 6 and 7 further incorporating a useable first operating face 502 and second operating face 503, operating on the only 2 useable fastener 40 driven half faces 43. Half inch drive examples made to their quoted specification as in FIG. 6, from highest grade chrome molybdenum, correctly hardened, snugly fitted and fully engaged completely failed at approx. 59 Nm/514 in lbs far short of their quoted 1,800 inch lbs minimum working torque. The present invention 1 made to identical size specifications, material and hardness still functioning without damage at 2,400 in lbs the ASME B107 standard proof torque for the particular ⅝″ size as denoted in FIG. 6 of U.S. Pat. No. 4,688,454 used throughout being 250 in lbs.

FIG. 13 even further illustrates a typical side entry prior art bicycle wrench 506 comprising, an open part hexagonal profile 508 and full hexagonal profile 507. A bicycle wrench 506 wrench head 500 made from correctly hardened chrome molybdenum, with similar depth to that of U.S. Pat. No. 4,688,454 gives approximately the same proof rating to that of a wrench constructed to U.S. Pat. No. 4,688,454.

It will be understood that each of the elements described above, or two or more together, may also find a useful application in other types of constructions differing from the types above. Whilst the invention has been illustrated and described as embodiments of a three jaw wrench, accordingly it is not limited to the details shown, since it will be understood that various omissions, modifications, substitutions and changes in the forms and details of the device illustrated and its operation can be made by those skilled in the art without departing in any way from the spirit of the invention.

1. A three jaw wrench 1 or socket portion 326 comprises:
an inner drive profile 301 configured to grip in the drive torque direction D correspondingly near sized hexagonal fasteners 40 drive half faces 43 by first 307, second 308 and third 309 torque application points forming a triangulated grip operating profile 305 having generally equidistant torque application points 306, one engaging each second corresponding hexagonal fastener head 41 driven half face 43 in the direction of torque application D, the occurring projected forces PF simultaneously self centring and purposely automatically adjusting, equally applies the projected force PF via said equidistant torque application points 306, to the worked fastener driven half faces 43, any slight variances in fastener drive flat to flats 42, manufacturing tolerances or worn or damaged fastener drive flats 42, 46 being automatically compensated for in the same manner as a three legged stool compensates for an uneven floor.

2. A three jaw wrench or socket portion as claimed in claim 1, wherein:
said triangular grip operating profile 305 comprises inner hex. Drive profile flat faces 314 having torque application point radiused leading edges 313 in order to minimize the damage to said driven hexagonal fastener head 41 driven half faces, said inner drive profile 301 having a notionally generally hexagonal shape 315.

3. A three jaw wrench 1, or socket portion 326, as claimed in claim 2, wherein:
a leading edge radius front aspect 327 of said radiused leading edge 313 merges with the inner drive hex. Profile flat faces 314, a leading edge radius rear aspect 328 comprises a larger smooth radius or straight profile merging into the inner operating profile 301, or further torque application point arcuate recesses 312, said leading edge radius 313 nearest in best practice merging into the adjacent concave arcuate corner profiles 311, the said torque application points radiused leading edges 313 may be singular or in sets.

4. A three jaw wrench 1, or socket portion 326, as claimed in claim 1, further comprising:
triangulated grip operating profiles 305 within the inner operating profile 301 of which can comprise toothed, serrated or generally roughened gripping profiles, in best practice the equidistant torque application points 306 utilizing torque application point radiused leading edges 313 are characterized by the inscribed circle 326 of said equidistant torque application points 306 being generally equivalent to the worked fastener 40 inscribed circle 45 thereby being further capable of automatically self-centring upon and equally operating on at full force drive torque D, any undulations 46 still remaining comprising the worked fastener worn or damaged 46 driven half faces 43 out with the fastener inscribed circle 45.

5. A three jaw wrench 1 or socket portion 326 as claimed in claimed in claim 1,
characterised by utilizing a closed box head portion 320, having an inner drive profile 301 incorporating three generally equidistant torque application points 306, gripping in a single or dual, drive torque direction D correspondingly near sized hexagonal fastener head 41, driven half faces 43 by three separate first 307, second 308 and third 309 dual sets of torque application points 325, one said set 325 engaging each second corresponding hexagonal fastener head 41 driven half face 43 in the operated drive direction torque D application.

6. A three jaw wrench 1 or socket portion 326 as claimed claim 1,
further characterized, whereas the optimum point of engagement between the three generally equidistant torque application points 306 and the fastener driven half faces 43, when used on undamaged fasteners is approximately 8-20% of the length of the operated fastener drive flat face 42 from the driven half 43 hex corner points 44 and no more than 4 mm in from the adjoining fastener hex corner 44 on the largest wrench 1 head portion 300 sizes,

7. A three jaw wrench 1 or socket portion 326 as claimed in claim 1,
configured such that when, in use, said three jaw wrench 1 or socket portion 326 is operated in the drive torque direction D upon a fastener 40 drive flats 42 comprising severely worn or damaged fastener undulations 46 operated by the first 307, second 308 and third 309 torque application point radiused leading edges 313, in extreme cases, only the said radiused leading edges 313 created at the intersection of the inner torque application point arcuate recesses 312 and the inner drive hex. Profile flat faces 314 can usefully impart projected force PF upon the worn or damaged fastener undulations 46, the torque application point radiused leading edges 313 created at the intersection of the concave arcuate corner profiles 311 and the inner drive hex. Profile flat faces 314 in this instance could be redundant, the triangulated operating profile 305, further capable of robustly operating 5% undersized or near undersized inch/metric fastener 40 sizes.

8. A three jaw wrench 1 or socket portion 326 as claimed in claim 1,
wherein the inner drive hexagonal profile flat faces 314 have concave arcuate corner profiles 311, and
wherein the torque application point radiused leading edges 313 formed at the point of convergence between the inner drive hex. Profile flat faces 314 of the first and third jaws 302, 304 and said concave arcuate corner profiles 311 create the first jaw 302 and third jaw 304 torque application point radiused leading edges 313, further radiused leading edges 313 formed within said inner drive hexagonal profile flat faces 314 by further torque application point arcuate recesses 312, the second jaw outer point forming the second torque application point 308, these triangular grip operating profile 305 torque application point radiused leading edges 313, capable of engaging correspondingly sized fastener drive flat 42 driven half faces 43 in the direction of the drive torque application D.

9. A three jaw wrench 1 or socket portion 326 as claimed in claim 2, where the configuration is such that
any occurring drive force reaction FR incurred by the torque application point radiused leading edges is directed into the deepest parts of the three jaw wrench 1 or socket portion 326, head portion 300 and handle portions 20.

10. A three jaw wrench 1 as claimed in claim 1,
comprising a handle portion and a head portion
said head portion provided with said inner drive profile and comprising a first jaw, a second jaw and a third jaw, and
further characterized by the second torque application point 308 which in use is under compression being incorporated within the second jaw 303 to a point of convergence 21, 317 between the handle portion 20 and the head portion 300, the second jaw 303 having an outer point 329 forming torque application point radiused leading edge 313, this results in a far greater inherent three jaw wrench 1 head portion 300 torque capability as the first and third jaw 302, 304 which in use are under tension being pulled around against the worked fastener 40 driven half faces 43 the second torque application point 308 being under compression pushing its corresponding driven half face 43.

11. (canceled)

12. (canceled)

13. A wrench head comprising a body that comprises a plurality of inner surfaces defining a fastener receiving recess to receive a polygonal fastener, said inner surfaces defining a first torque applying projection, a second toque applying projection and a third torque applying projection, said torque applying projections being configured to engage a polygonal fastener received in said fastener receiving recess and to lie at respective corners of an imaginary equilateral triangle formed by drawing imaginary lines to connect said first, second and third torque applying projections.

14. A wrench head as claimed in claim 13 in the form of a three jaw open end wrench head.

15. A wrench head as claimed in claim 13 in the form of a socket.

16. A wrench head as claimed in claim 15, wherein said inner surfaces define fourth, fifth and sixth torque applying projections configured to engage said polygonal fastener and lying at respective corners of a second imaginary equilateral triangle formed by drawing imaginary lines to connect said fourth, fifth and sixth torque applying projections, said imaginary equilateral triangles being rotationally offset.

17. A wrench head as claimed in claim 13, wherein said torque applying projections are ridges having a radiused leading edge.

18. A wrench head as claimed in claim 13, wherein said inner surfaces define fourth, fifth and sixth torque applying projections configured to engage said polygonal fastener and lying at respective corners of a second imaginary equilateral triangle formed by drawing imaginary lines to connect said fourth, fifth and sixth torque applying projections, said imaginary equilateral triangles being rotationally offset, said first and fourth torque applying projections disposed side-by-side and separated by a recess to define a first torque applying projection pair, said second and fifth toque applying projections disposed side-by-side and separated by a recess to define a second torque applying projection pair and said third and sixth torque applying projections disposed side-by-side and separated by a recess to define a third torque applying projection pair.

19. A wrench head as claimed in claim 18, wherein said inner surfaces are configured with a plurality of relieving recesses such that adjacent said first, second and third torque applying projection pairs are separated by respective relieving recesses, whereby said inner surfaces engage said polygonal fastener only by said first, second and third torque applying projection pairs.
